(19) United States
(12) Patent Application Publication
(10) Pub. No.: US 2026/0246378 A1
(43) Pub. Date: Aug. 20, 2026

(54) CHARGE PUMP CIRCUIT

(71) Applicant: ABLIC INC., Nagano (JP)

(72) Inventors: Keisuke NAGAO, Nagano (JP); Tsutomu TOMIOKA, Nagano (JP)

(21) Appl. No.: 19/451,650

(22) Filed: Jan. 16, 2026

(30) Foreign Application Priority Data
Feb. 18, 2025 (JP) 2025-023949

(51) Int. Cl. H02M 3/07

(52) U.S. Cl. CPC H02M 3/07

(57) ABSTRACT

Provided is a charge pump circuit including a plurality of pump cells connected in series, at least one stage number changing circuit, and a power supply voltage detection circuit. The plurality of pump cells include a first stage pump cell formed of a low-voltage element configured to receive an input voltage, and at least one remaining pump cell formed of a high-voltage element. The remaining pump cells include a final stage pump cell connected to an output terminal. The at least one stage number changing circuit is connected in parallel to a the at least one remaining pump cell. The power supply voltage detection circuit is configured to control the remaining pump cells and the stage number changing circuit so as to selectively stop and bypass a corresponding pump cell of the remaining pump cells in accordance with a voltage range of the detected input voltage.

### BACKGROUND OF THE INVENTION

### 1. Claim for Priority

This application claims the benefit of priority of Japanese Application No. 2025-023949, filed Feb. 18, 2025, which is hereby incorporated by reference in its entirety.

### 2. Field of the Invention

The present invention relates to a charge pump circuit.

### 3. Description of the Related Art

In an IC that provides a small power supply voltage, a charge pump (hereinafter referred to as “CP”) is often used in a case in which a large output voltage is desired to be provided or a circuit having a high minimum operating voltage is desired to be applied. The CP is a circuit that operates by receiving a power supply voltage or an internal power supply voltage as an input voltage and ideally provides a voltage that is double the input voltage as output. The input voltage can be provided as a voltage multiplied by the number of stages by connecting the output of a preceding stage to the input of a subsequent stage. (However, the boosting efficiency actually decreases because of the influence of parasitic capacitance, backflow current within the CP, and the like.)

An example of a drawback of the CP is that current consumption is large. The current consumption increases because a load current of the CP is multiplied by the number of stages of the CP. In addition, the current consumption further increases because of the influence of parasitic capacitance and backflow current that are added to the circuit. This often becomes an issue in IC design. In order to suppress the current consumption, the following methods are given.

When a circuit in which CPs are stacked in multiple stages is configured, it is desired that a flying capacitor (hereinafter referred to as “Cfly”) for handling boosting in the first stage be a metal-oxide-semiconductor (MOS) capacitor that is used as a low-voltage (hereinafter referred to as “LV”) element in a case in which a power supply voltage is LV. The reason therefor is because a MOS capacitor has a larger capacitance value per unit area and a smaller parasitic capacitance on an upper electrode (gate electrode) side as compared to a high-voltage (hereinafter referred to as “HV”) element such as a metal-oxide-metal (MOM) capacitor because a distance between electrodes is small. That is, the area of the Cfly can be reduced by applying the LV element. Further, a reduction effect of current consumption can also be expected because the parasitic capacitance can be reduced. A pump cell in the final stage is usually formed of an HV element because HV is often applied thereto. However, the LV element can be used for at least the first stage pump cell because HV is not applied thereto.

Further, the above-mentioned effect can be further enhanced by adjusting a ratio between a capacitance value of the Cfly of a pump cell formed of an LV element and a capacitance value of the Cfly of a pump cell formed of an HV element. That is, a pump cell formed of an LV element has a feature of having large boosting efficiency and small current consumption relative to the area. Accordingly, with the ratio between the capacitance value of the Cfly of the pump cell formed of the LV element and the capacitance value of the Cfly of the pump cell formed of the HV element being set so that the LV element side becomes larger, the ratio of the voltage to be handled by the LV pump cell at the time of boosting is increased. Thus, a larger advantage can be enjoyed in terms of area and current consumption.

As a countermeasure against current consumption, one example is a circuit devised to calculate the required number of CP stages from an input voltage and operate the CP only for the required number of stages (see, for example, Japanese Patent Application Laid-open No. 2014-23430).

However, in the related-art circuit configuration as described in Japanese Patent Application Laid-open No. 2014-23430, the final stage pump cell that is usually formed of an HV element cannot be stopped and bypassed. Consequently, in a case in which the required number of CP stages is one, the first stage pump cell is also a target for stopping and bypassing. Thus, a pump cell that can be formed of an LV element that is advantageous in terms of area and current consumption cannot be used. The related-art circuit configuration has room for improvement because optimization based on used elements is insufficient from the viewpoints of current consumption and boosting efficiency.

### SUMMARY OF THE INVENTION

The present invention has an object to provide a charge pump circuit for which optimization based on used elements is sufficient from the viewpoints of current consumption and boosting efficiency.

According to at least one embodiment of the present invention, there is provided a charge pump circuit including a plurality of pump cells connected in series, at least one stage number changing circuit, and a power supply voltage detection circuit. The plurality of pump cells include a first stage pump cell formed of a low-voltage element configured to receive an input voltage, and at least one remaining pump cell formed of a high-voltage element. The at least one remaining pump cell includes a final stage pump cell connected to an output terminal. The at least one stage number changing circuit is each connected in parallel to a corresponding one of the at least one remaining pump cell. The power supply voltage detection circuit is configured to control the at least one remaining pump cell and the at least one stage number changing circuit so as to selectively stop and bypass a corresponding pump cell of the at least one remaining pump cell in accordance with a voltage range of the detected input voltage.

According to the at least one embodiment of the present invention, it is possible to provide the charge pump circuit for which optimization based on used elements is sufficient from the viewpoints of current consumption and boosting efficiency.

### BRIEF DESCRIPTION OF THE DRAWINGS

FIG. 1 is a circuit diagram for illustrating a configuration example of a charge pump circuit according to a first embodiment of the present invention.

FIG. 2 is a circuit diagram for illustrating a configuration example of a charge pump circuit according to a second embodiment of the present invention.

### DESCRIPTION OF THE EMBODIMENTS

A charge pump circuit according to embodiments of the present invention is described below with reference to the drawings. For convenience of description, illustration of a part of the configuration may be omitted or the scale thereof may be changed.

### First Embodiment

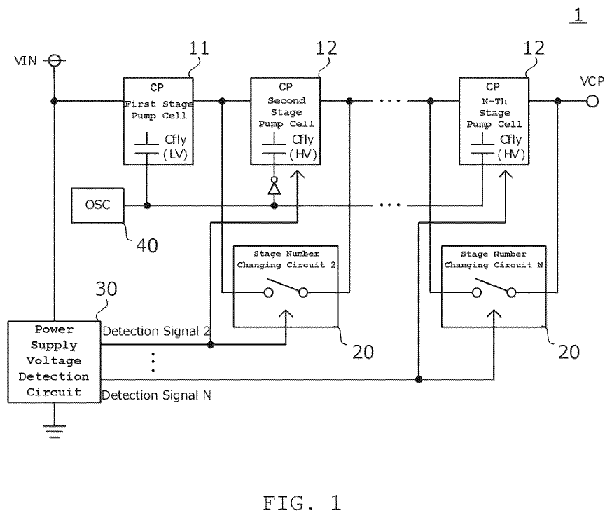

FIG. 1 is a circuit diagram for schematically illustrating a configuration of a charge pump circuit 1 which is an example of a charge pump circuit according to a first embodiment of the present invention.

The charge pump circuit 1 includes an input terminal VIN, an output terminal VCP, a plurality of pump cells 11 and 12, at least one stage number changing circuit 20, a power supply voltage detection circuit 30, and an oscillation circuit 40.

The plurality of pump cells 11 and 12 include a first stage pump cell 11 formed of an LV element that is advantageous in terms of area and current consumption, and at least one remaining pump cell 12 formed of an HV element.

The plurality of pump cells 11 and 12 are connected in series between the input terminal VIN for receiving an input voltage and the output terminal VCP for providing an output voltage. The first stage pump cell 11 is connected to the input terminal VIN. The final stage (N-th stage) pump cell 12 (N-th stage) of the at least one remaining pump cell 12 is connected to the output terminal VCP.

The at least one stage number changing circuit 20 is each connected in parallel to a corresponding one of the at least one remaining pump cell 12. Specifically, the at least one stage number changing circuit 20 includes a stage number changing circuit 20 (stage number changing circuit 2) connected in parallel to the second stage pump cell 12 (second stage) to a stage number changing circuit 20 (stage number changing circuit N) connected in parallel to the final stage pump cell 12 (N-th stage).

The power supply voltage detection circuit 30 provides at least one detection signal in accordance with a voltage range of the detected input voltage. The power supply voltage detection circuit 30 controls the at least one remaining pump cell 12 and the at least one stage number changing circuit 20 so as to selectively stop (disable) and bypass a corresponding pump cell 12 of the at least one remaining pump cell 12. Specifically, the power supply voltage detection circuit 30 can provide a detection signal (detection signal 2) to stop the second stage pump cell 12 (second stage) and turn on a switch inside the stage number changing circuit 20 (stage number changing circuit 2) connected in parallel to the second stage pump cell 12, to thereby create a path for bypassing the pump cell 12 (second stage). Further, the power supply voltage detection circuit 30 can provide a detection signal (detection signal N) to stop the final stage (N-th stage) pump cell 12 (N-th stage) and turn on a switch inside the stage number changing circuit 20 (stage number changing circuit N) connected in parallel to the final stage pump cell 12, to thereby create a path for bypassing the pump cell 12 (N-th stage).

The oscillation circuit 40 is connected to the plurality of pump cells 11 and 12. The oscillation circuit 40 supplies a clock to the pump cell 11 and the pump cell 12. The clock supplied to an even-numbered stage pump cell is required to be formed so that an H level and an L level are inverted with respect to the clock supplied to an odd-numbered stage pump cell. Accordingly, the pump cell that is a target for stopping and bypassing is required to be selected carefully so that the CP operates correctly, in accordance with the voltage range of the input voltage detected by the power supply voltage detection circuit 30.

As described above, the charge pump circuit 1 according to the first embodiment can stop and bypass the at least one remaining pump cell 12 in accordance with the voltage range of the input voltage. Thus, the first stage pump cell 11 that is advantageous in terms of area and current consumption can be used. Accordingly, the charge pump circuit 1 according to the first embodiment can provide a charge pump circuit for which optimization based on used elements is sufficient from the viewpoints of current consumption and boosting efficiency.

### Second Embodiment

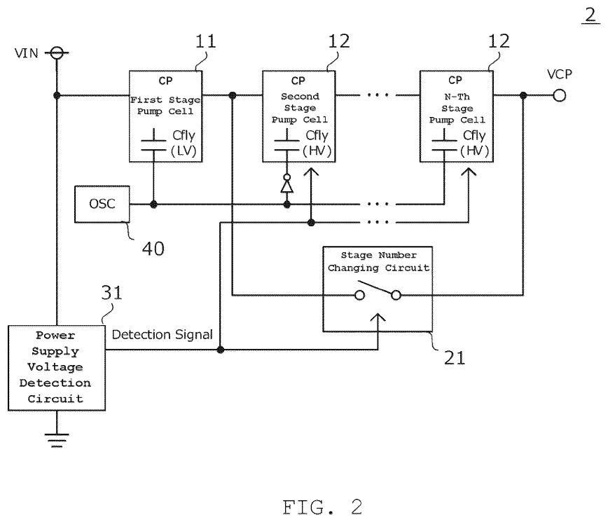

FIG. 2 is a circuit diagram for schematically illustrating a configuration of a charge pump circuit 2 which is an example of a charge pump circuit according to a second embodiment of the present invention.

The charge pump circuit 2 is different from the charge pump circuit 1 in that the charge pump circuit 2 includes a single stage number changing circuit 21 and a power supply voltage detection circuit 31 instead of the at least one stage number changing circuit 20 and the power supply voltage detection circuit 30, but the charge pump circuit 2 is substantially not different in other respects from the charge pump circuit 1. In view of the above, in the second embodiment, the description focuses on the single stage number changing circuit 21 and the power supply voltage detection circuit 31. In the description of the charge pump circuit 2 of the following embodiment, the same reference symbols are assigned to components that are substantially not different from those of the charge pump circuit 1, and descriptions thereof are omitted.

The single stage number changing circuit 21 is connected in parallel to the at least one remaining pump cell 12. That is, the single stage number changing circuit 21 is connected in parallel to the second stage pump cell 12 (second stage) to the final stage pump cell 12 (N-th stage) connected in series.

The power supply voltage detection circuit 31 provides a single detection signal in accordance with a voltage range of the detected input voltage. The power supply voltage detection circuit 31 controls all of the at least one remaining pump cell 12 and the single stage number changing circuit 21 so as to stop (disable) and bypass all of the at least one remaining pump cell 12. Specifically, the power supply voltage detection circuit 31 can provide a detection signal (detection signal) to stop the second stage pump cell 12 (second stage) to the final stage (N-th stage) pump cell 12 (N-th stage) and turn on a switch inside the single stage number changing circuit 21 connected in parallel to the second stage pump cell 12 (second stage) to the final stage pump cell 12 (N-th stage), to thereby create a path for bypassing the second stage pump cell 12 (second stage) to the final stage pump cell 12 (N-th stage). The remaining configuration is substantially not different from that of the charge pump circuit 1. Thus, descriptions thereof are omitted.

As described above, the charge pump circuit 2 according to the second embodiment can stop and bypass the at least one remaining pump cell 12 in accordance with the voltage range of the input voltage. Thus, the first stage pump cell 11 that is advantageous in terms of area and current consumption can be used. In addition, the stage number changing circuit 21 can operate as a single unit. Thus, the area can be reduced as compared to the first embodiment in a case in which detailed adjustment of the number of CP stages is not required. Accordingly, the charge pump circuit 2 according to the second embodiment can provide a charge pump circuit for which optimization based on used elements is sufficient from the viewpoints of current consumption and boosting efficiency.

The present invention is not limited to the embodiments described above as they are. At the implementation stage, the present invention can be implemented in various forms in addition to the embodiments described above, and various omissions, additions, substitutions, or changes can be made without departing from the gist of the invention. For example, various capacitive elements may be used as the capacitive element, such as metal-oxide-semiconductor (MOS) capacitors, metal-insulator-metal (MIM) capacitors, and metal-oxide-metal (MOM) capacitors.

The embodiments and modifications thereof described above are encompassed in the scope and the gist of the invention, and are encompassed in the invention defined in the appended claims and equivalents thereof.

1. A charge pump circuit, comprising:
a plurality of pump cells connected in series;
at least one stage number changing circuit; and
a power supply voltage detection circuit,
wherein the plurality of pump cells include a first stage pump cell formed of a low-voltage element configured to receive an input voltage, and at least one remaining pump cell formed of a high-voltage element, the at least one remaining pump cell including a final stage pump cell connected to an output terminal,
wherein the at least one stage number changing circuit is connected in parallel to the at least one remaining pump cell, and
wherein the power supply voltage detection circuit is configured to control the at least one remaining pump cell and the at least one stage number changing circuit so as to selectively stop and bypass a corresponding pump cell of the at least one remaining pump cell in accordance with a voltage range of the detected input voltage.

2. The charge pump circuit according to claim 1,
wherein the at least one stage number changing circuit comprises a single stage number changing circuit connected in parallel to the at least one remaining pump cell, and
wherein the power supply voltage detection circuit is configured to control the at least one remaining pump cell and the single stage number changing circuit so as to stop and bypass the at least one remaining pump cell.
